(19) United States
(12) Patent Application Publication
(10) Pub. No.: US 2009/0134561 A1
(43) Pub. Date: May 28, 2009

(54) Work support

(75) Inventors: Yan Wang, Nottingham (GB); Dongfeng Shi, Stapleford (GB); Jianfan Xie, Furzton (GB); Nabil Gindy, Loughborough (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/289,897

(22) Filed: Nov. 6, 2008

(30) Foreign Application Priority Data
Nov. 22, 2007 (GB) 0722831.5

(51) Int. Cl. B25B 5/00

(52) U.S. Cl. 269/86

(57) ABSTRACT

Work support arrangements 1 are provided in order to support work pieces 20 when it is necessary to machine those work pieces 20. The work pieces 20 may simply passively rest upon contact ends 6, 16 or be in compressive engagement to retain position but in either event it is advantageous to determine contact force. By providing a contact pad element 15 which directly provides contact force at an interface between contact end 6, 16 and the work piece 20 without taking any load force itself robust determination of contact force is achieved. Generally, the contact pad element 15 is suspended upon a guide 13 extending from a mounting such as an actuator seat 11.

The present invention relates to work supports and more particularly to work supports incorporating a force sensor to determine variations in contact force and pressure between the work support and a work piece in use particularly when that work piece is subject to machining forces.

It will be appreciated that it is often necessary to machine work pieces such as initial cast pre forms to a final acceptable component configuration. In order to perform these machining processes the work piece is supported appropriately. In order to support work pieces generally a compressive pressure or force is advantageous between a work support arrangement and the work piece to be supported. This contact pressure or force is typically achieved through hydraulic or pneumatic piston actuators which displace a contact end into engagement with the work piece in order to robustly present and support the work piece in use.

Clearly, with regard to machining it will be understood that machining forces of an appropriate nature will always be applied to the work piece in order to mill or otherwise alter the configuration of the work piece as required. These machining forces can distort and damage the work piece if that work piece is not appropriately supported and presented. However, conversely with thin walled or fragile work pieces it will be understood that excessive compressive contact pressures and forces presented by the work support itself can cause damage and distortion. In such circumstances it is known to provide relatively intelligent work supports which typically through work piece identification, work piece location and actuators allow re-positioning of the work piece to enable support adaptation is achieved in order to reduce damage to that work piece when machined. Furthermore, it is also known to provide adaptive work support fixings which can monitor machining forces on a work piece and provide additional clamping forces when required. In such circumstances these prior work supports are relatively expensive and are designed to be reactive as indicated through means for determining compound position and identification using scanners etc., determining component location through an appropriate vision system and typically, as indicated, through use of adaptive fixings to allow adjustment in machining forces and/or clamping forces to reduce machining deformation. In such circumstances work support arrangements are therefore provided which are typically dedicated for a particular work piece and will require significant adaptation for work piece change overs. Ideally, the work support arrangement should incorporate a number of work supports which can simply oppose machining forces and increase the rigidity of the work support arrangement to work piece combination when required, or simply provide an alarm when an imbalance is detected.

In accordance with aspects of the present invention there is provided a work piece support arrangement for a thin walled work piece subject to machining, the arrangement comprising a plurality of work supports each having a contact pad element presented upon a mounting arrangement and a force sensor to determine contact pressure between the contact pad and the work piece, the support characterised in that the contact pad element is suspended upon a guide and a part of the contact pad element engages the force sensor on one side whereby a contact force is presented to the contact pad through the force sensor only.

Typically, the contact pressure is provided by an actuator.

Generally, the guide comprises an elongate member. Typically, the elongate member comprises a bolt or rail. Typically, the guide incorporates a retainer to capture the contact pad. Possibly, the retainer is a bolt head. Alternatively, the guide comprises a sleeve within which the contact pad is displaceable. Generally, the guide facilitates axial alignment of the contact pad element with the mounting arrangement.

Generally, the guide is secured in an actuator seat. Possibly, the length of the guide is adjustable. Typically, the force sensor is engaged on an opposite side to the contact pad by an actuator seat. Typically, the actuator seat is displaceable. Generally, the actuator seat is displaceable by a piston movement provided by a hydraulic or pneumatic or electrical servo motor prime movement.

Generally, the actuator is secured upon a ring or work support structure for presentation of the contact pad element.

Normally, the contact pad comprises a contact end and a hollow member with a cavity within which the guide is captured.

Typically, the work supports are located in a plurality of rings or other structural elements. Typically, each ring or structural element has a plurality of work supports with respective contact pad elements extending outwardly therefrom.

Generally, each contact pad is arranged to have a predetermined force against a work piece in use provided by configuration of the contact pad element. Typically, the configuration of the contact pad element is by translation along a screw thread into engagement with a work piece in use. Generally, the configuration of the contact pad element is achieved by appropriate displacement of the work support by an actuator.

Generally, the force sensor is arranged to determine variation in contact pressure indicative of chatter on compression of the contact pad against a work piece and provide a control signal to a controller. Generally, the controller receives the control signal and provides a warning and/or indication to a user dependent upon a level of chatter determined by the force sensor and reported by the control signal.

Typically, the work support arrangement incorporates adjustment elements to vary the position of the work supports in accordance with aspects of the present invention. Generally, the adjustment elements comprise spacers for location between the work supports.

An embodiment of aspects of the present invention will now be described by way of example and with reference to the accompanying drawings in which:

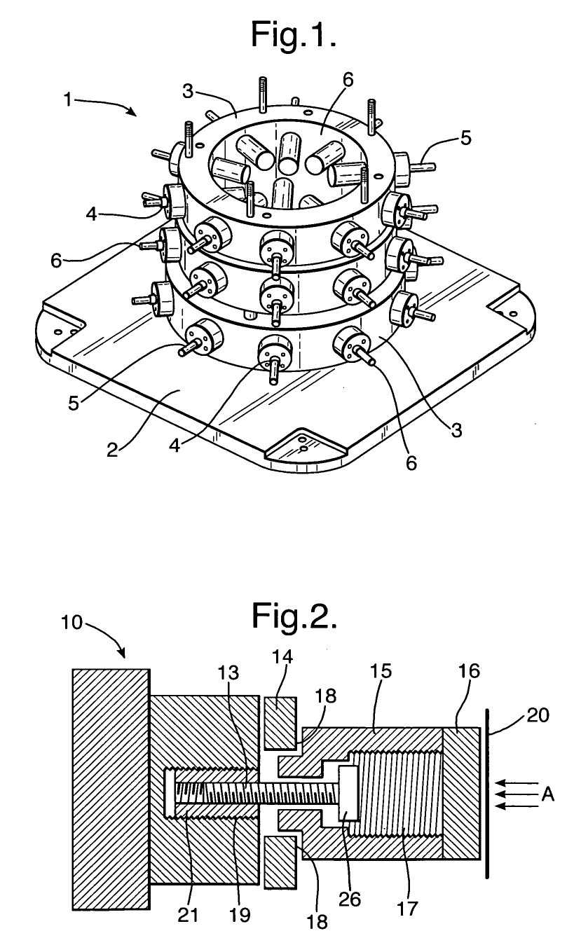

FIG. 1 is a schematic illustration of a work support arrangement in accordance with aspects of the present invention; and,

FIG. 2 is a schematic side cross section of a work support in accordance with aspects of the present invention.

As indicated above, provision of intelligent support arrangements for work pieces subject to machining forces is advantageous. However, it would be desirable to avoid excessive complexity and limiting bespoke features of the work supports arrangements for a particular work piece or component article to be machined. Each work support arrangement comprises a number of work supports arranged to measure machining deformation, machining force and vibration of the work piece during machining processes. Furthermore, early detection of so called chatter where the work piece deforms and therefore causes oscillations in the contact or force pressure between the work support and the work piece would be advantageous. Such chattering may be indicative of loss of strength in the support arrangement or leakage in actuators to provide contact pressures such as hydraulic or pneumatic piston actuators displacing the contact elements.

FIG. 1 provides a schematic illustration of a work support arrangement 1 in accordance with aspects of the present invention. The arrangement 1 comprises a base 2 upon which a number of structural rings 3 are located in a stack. It will be appreciated that configuration of the arrangement may be varied by introducing spacers between the rings 3 such that the height of the arrangement 1 can be varied. Although rings 3 are depicted in FIG. 1 it will be understood that work supports 4 could be mounted in any structural configuration such that contact pad elements 5 extend axially and normally outwardly in order to provide contact ends 6 which engage a work piece or component article in use for support against machining forces. Within the stack of rings 3 it will be noted that hydraulic or pneumatic piston actuators are provided in order to enable outward lateral displacement of the contact pad elements 5 into engagement with a work piece in use. In such circumstances generally a predetermined initial contact force or pressure is presented through the ends 6 against the work piece (not shown) in order to robustly support that work piece against machining pressures.

In a practical work support arrangement 1 in accordance with aspects of the present invention generally a number of sensors will be provided. Aspects of the present invention particularly relate to force sensors utilised with regard to the contact pad elements 5. Other sensors may be provided to determine displacement between work supports and also an accelerometer to determine motion of the arrangement 1.

Signals from the sensor will be collected and processed by a controller in order to provide warnings and indicators to a user operator with regard to the contact pressures and other control parameters with respect to the arrangement 1 in use. Generally, a set of acceptable manufacturing tolerances will be determined and the measured displacement information provided by the sensor through the controller utilised for comparison and to provide the warnings and indications as outlined above.

The force sensors in accordance with aspects of the present invention measure the reaction forces in the work support between that work support and a work piece in use. The evaluation is generally against retaining or holding forces applied by a hydraulic or pneumatically operated piston causing displacement of the contact pad element and therefore the contact end 6 into engagement with a work piece in use. However, a passive system may be provided where simply through translation along a screw thread displacement of the work piece arrangement can be achieved to cause compressive engagement between the ends 6 and a work piece. It will be understood that such translation will be achieved by turning the support upon the screw thread and such turning may be against a torque set ratchet to achieve the desired contact pressures. However, clearly use of a displaceable piston provides more automation and therefore is advantageous.

As indicated in addition to force sensors an accelerometer may be used for measuring vibration and to allow evaluation if chattering, that is to say oscillations, in the presented contact force or pressure occurs. A pressure switch is typically provided within the hydraulic or pneumatic displacement system and in such case if leakage occurs the hydraulic pressure will drop below a set point and the pressure switch will close resulting in an alarm and possible shut down in view of the reduced holding pressures of the work support arrangement 1 against a work piece (not shown) in use. In any event, generally if the sensors measure results which are out of a predefined limit set, an indication and/or warning will be provided to the user operator to allow a determination as to whether to stop machine operation and investigate further.

A force sensor is mounted into the work supports 4 such that it is possible to ascertain and determine a pre load presented through the contact pad element 5 and end 6 to a work piece. It will be understood that there must be some pre loading in order to provide a compressive engagement force for the arrangement 1 to retain a work piece against machining forces. In such circumstances the force sensor measures variation reaction forces on the work piece supported which, as indicated, combines the structural strength of the work piece and opposing machining forces. By aspects of the present invention the force sensor is mounted such that it can measure entire machine forces against the base pre determined contact pressure or force. This is achieved by ensuring that the contact pad element is essentially suspended in contact on one side of the pressure sensor such that all of the forces are presented directly upon the force sensor whilst other elements such as a guide to locate and position the force sensor in use translate or receive none of the machining or contact force.

As indicated above, a work support arrangement 1 in accordance with aspects of the present invention will generally incorporate a number of work supports appropriately mounted for presentation of contact ends to be engaged in use by a work piece. All of these work supports may be configured in accordance with aspects of the present invention or a representative number of such work supports have sensors in accordance with aspects of the present invention whilst other work supports are passive.

FIG. 2 illustrates a typical schematic cross section of a work support 10 in accordance with aspects of the present invention. The work support 10 comprises a mounting including an actuator seat 1 arranged to be located within a structural component of a work support arrangement such as rings 3 as depicted in FIG. 1. The work support 10 incorporates a contact end 16 which is part of a contact pad element 15. In use the contact end 16 engages a component or work piece 20 such that machining forces are presented in the direction of arrowheads A. Normally, on initial set up the contact end 16 engages a work piece 20 with a predetermined contact force determinable by a force sensor 14. The force sensor 14 engages one side of the contact pad element 15 such that the forces presented about the interface between the contact ends 16 and the component or work piece 20 are translated through the element 15 to the sensor 14. At the opposite side, the actuator seat 11 engages the sensor 14 such that the sensor 14 is essentially sandwiched between the contact pad element 15 and the seat 11 in order to generate signals for receipt by a controller (not shown) indicative of contact pressures at the interface between the end 16 and the work piece 20.

In accordance with aspects of the present invention all contact pressure through the support 10 is all provided through the sensor 14. As can be seen, the contact pad element 15 is suspended upon a guide 13 which extends into the actuator seat 11. The guide, as depicted in FIG. 2, is a bolt secured through a screw thread in the actuator seat 11 in order to extend outwardly with a retainer 16 used to ensure that the contact pad element 15 is captive. It will be noted that the contact pad element 15 in the embodiment depicted in FIG. 2 incorporates a cavity or hollow 17. In such circumstances the suspension of the contact pad element 15 allows displacement axially typically in the direction of the guide 13 in order to translate forces at the interface between the end 16 and the work piece 20 appropriately. In order to achieve appropriate positioning it will be noted that the guide 15 may be variously displaced in order to appropriately be presented as an elongate element upon which the contact pad element 15 can be presented.

It will be noted that the force sensor 14 is essentially held captive by adopting a ring or collar configuration extending about the guide 13 such that, as indicated above, forces are presented to the sensor 14 directly whilst the means of retention, that is to say the guide 13, is isolated from translation of contact and machining forces at the interface between the end 16 and the work piece 20.

As indicated, pre loading of the force upon the sensor 14 can be achieved by displacement of the actuator seat 11 to cause inter engagement between the end 16 and the work piece 20. However, in order to ensure operational pre loading of the force sensor 14 it may be advantageous to utilise the guide 13 such that the retainer 16 engages a part of the hollow or cavity 17 such that there is compression about an interface 18 between the sensor 14 and a part of the contact pad element 15. In such circumstances machining forces in the direction of arrowhead A acting on the work piece 20 which is in contact with the end 16 will transfer directly to the sensor 14 through the element 15 in order to create control signals for appropriate use.

As indicated, generally the actuator seat 11 will be associated with other work support components as described previously with regard to FIG. 1 including an actuator to displace the work piece laterally for engagement about the interface between the end 16 and work piece 20. To enable differing sized components to be secured in a standard presented screw thread aperture 19 of the seat 11, an adaptor 21 may be provided. Thus, the guide 30 is secured which in turn allows capture of the contact pad element 15 and capture of the sensor 14 under pre loading as required.

In accordance with aspects of the present invention, as indicated, a controller is arranged to receive control signals from the sensor 14. These control signals will allow measurement of machining forces in the direction of arrowhead A as well as deformation and vibration through the work support 10. By appropriate comparison with expected tolerance values and conditioning through machining processes and evaluation of performance an early warning is provided with regard to deviations which may be indicative of distortion and damage to the work piece 20. Furthermore, where the actuator incorporates hydraulic pistons or ram loss of contact pressure between the end 16 and the work piece 20 may be indicative of oil leakage and therefore an appropriate alarm raised for further investigation. It will also be understood that through the additional intelligent control signals provided by the sensor 14 better operator control of the machining processes will be achieved and an ability to maintain optimum machining parameters possible.

Aspects of the present invention allow provision of a work support and work support arrangement which, although achieving interactive control signals and therefore allowing intelligent control regimes, is not complicated and can achieve results by retro fit to existing passive work supports and work support arrangements. With an existing passive work support arrangement, as indicated, either directly or through an adaptor 21, the contact pad element 15 can be secured and captured by the guide with the sensor 14 sandwiched between that element 15 and parts of the seat 11. In such circumstances aspects of the present invention allow integration into existing machine tool control regimes and other mechanisms for appropriate process monitoring.

As indicated, pre loading of the sensor 14 is advantageous. In such circumstances use of a retainer 26 to cause compression between the element 15 and the sensor 14 on one side and the seat 11 on the other is appropriate. In order to achieve such compressions it is possible to remove the end 16 to allow access to the hollow cavity 17 such that through engagement with the retainer 26 a compressive force can be presented. Once that compressive force is achieved possibly through a torque wrench to a desired compression level the end 16 can be returned and secured appropriately to the remainder of the element 15.

As indicated above, the element 15 generally transfers the contact loadings to the sensor 14 from the work piece 20. In such circumstances the contact element 15 will be formed from robust materials such as steel and in particular the end 16 from an appropriate material to ensure transfer or direct translation of contact forces to the sensor 14. It will be understood it is desirable that the end 16 does not deform in use in engagement with the work piece 20.

Modifications and alterations to aspects of the present invention will be appreciated by those skilled in the art. Thus, rather than having an internal guide 13 for capture of the contact pad element 15, it will be understood that an external sleeve may be provided to act as the guide. The contact pad element would still be captured within that sleeve and allow axial presentation although it may be difficult to provide pre loading other than through compressive engagement with a work piece by a protruding end of the captive contact pad element.

We claim:

1. A work piece support arrangement for a thin walled work piece subject to machining, the arrangement comprising a plurality of work supports each having a contact pad element presented upon a mounting arrangement and a force sensor to determine contact pressure between the contact pad and the work piece, the support characterised in that the contact pad element is suspended upon a guide and a part of the contact pad element engages the force sensor on one side whereby a contact force is presented to the contact pad through the force sensor only.

2. A work piece support arrangement as claimed in claim 1 wherein the contact pressure is provided by an actuator.

3. A support as claimed in claim 1, wherein the guide comprises an elongate member.

4. A support as claimed in claim 3 wherein the elongate member comprises a bolt or rail.

5. A support as claimed in claim 1, wherein the guide incorporates a retainer to capture the contact pad.

6. A support as claimed in claim 5 wherein the retainer is a bolt head.

7. A support as claimed in claim 1, wherein the guide comprises a sleeve within which the contact pad is displaceable.

8. A support as claimed in claim 1, wherein the guide facilitates axial alignment of the contact pad element with the mounting arrangement.

9. A support as claimed in claim 1, wherein the guide is secured in an actuator seat.

10. A support as claimed in claim 1, wherein the length of the guide is adjustable.

11. A support as claimed in claim 1, wherein the force sensor is engaged on an opposite side to the contact pad by an actuator seat.

12. A support as claimed in claim 1, wherein the actuator seat is displaceable.

13. A support as claimed in claim 12, wherein the actuator seat is displaceable by a piston movement provided by a hydraulic or pneumatic or electrical servo motor prime movement.

14. A support as claimed in claim 2, wherein the actuator is secured upon a ring or work support structure for presentation of the contact pad element.

15. A support as claimed in claim 1, wherein the contact pad comprises a contact end and a hollow member with a cavity within which the guide is captured.

16. An arrangement as claimed in claim 1, wherein the work supports are located in a plurality of rings or other structural elements.

17. An arrangement as claimed in claim 16, wherein each ring or structural element has a plurality of work supports with respective contact pad elements extending outwardly therefrom.

18. An arrangement as claimed in claims 1, wherein each contact pad is arranged to have a predetermined force against a work piece in use provided by configuration of the contact pad element.

19. An arrangement as claimed in claim 18, wherein the configuration of the contact pad element is by translation along a screw thread into engagement with a work piece in use.

20. An arrangement as claimed in claim 18, wherein the configuration of the contact pad element is achieved by appropriate displacement of the work support by an actuator.

21. An arrangement as claimed in claim 1, wherein the force sensor is arranged to determine variation in contact pressure indicative of chatter on compression of the contact pad against a work piece and provide a control signal to a controller.

22. An arrangement as claimed in claim 21, wherein the controller receives the control signal and provides a warning and/or indication to a user dependent upon a level of chatter determined by the force sensor and reported by the control signal.

23. An arrangement as claimed in claim 22, wherein the work support arrangement incorporates adjustment elements to vary the position of the work supports dependent on the level of chatter determined by the force sensor.

24. An arrangement as claimed in claim 1, wherein the thin walled work piece is a cylindrical casing for a gas turbine engine.

25. An arrangement as claimed in claim 24, wherein the contact pad acts against an inside surface of the cylindrical casing.

26. An arrangement as claimed in claim 25, wherein the cylindrical casing is machined from an outside surface.
